(19) United States
(12) Patent Application Publication
(10) Pub. No.: US 2022/0011438 A1
(43) Pub. Date: Jan. 13, 2022

(54) MULTI-DOMAIN OPTICAL SENSOR CHIP AND APPARATUS

(71) Applicant: Xin Jin, Waterloo (CA)

(72) Inventor: Xin Jin, Waterloo (CA)

(21) Appl. No.: 17/194,389

(22) Filed: Mar. 8, 2021

Related U.S. Application Data
(63) Continuation-in-part of application No. 16/926,400, filed on Jul. 10, 2020.
Application No. 16/926,400 is a continuation-in-part of application No. 17/126,623, filed on Dec. 18, 2020.

(51) Int. Cl. G01S 17/931; G01S 17/26; G01S 7/481; G01S 17/89

(52) U.S. Cl. CPC G01S 17/931; G01S 17/89; G01S 7/4811; G01S 17/26

(57) ABSTRACT

In many applications such as autonomous vehicle and ADAS (advanced driver assistance system), both LIDAR sensor and camera sensor play important and complementary roles in sensing surroundings. The scanless LIDAR sensor on chip architecture disclosed in this application is suitable to build a LIDAR and a camera sensor on a single chip and share one set of optics, enabling a combined FMCW Doppler LIDAR and camera sensor inherently to work together and jointly sense directions simultaneously in parallel without mechanical, electronic or phonic scanning, no extra efforts needed to align them either. Lower costs, higher reliability, and faster detection as well as higher direction sensing accuracy and multi-domain sensing are objectives of this invention. The combined optical sensor provides object sensing information in multiple domains: angles of view (direction vector), distance, relative velocity, colors (in Red-Green-Blue victor) and light strength.

### CROSS-REFERENCE TO RELATED APPLICATION

This application is a continuation-in-part of application Ser. No. 16/926,400 filed on Jul. 10, 2020 and application Ser. No. 17/126,623 filed on Dec. 18, 2020.

### BACKGROUND OF THE INVENTION

### Field of the Invention

This invention relates generally to optical sensor, in particular, to a combined LIDAR and camera sensor.

### Description of the Related Art

LIDAR (light detection and ranging) devices are viewed as a major sensing means in an ADAS (advanced driver assistance system) of a vehicle, as well as in a driving control system of an autonomous vehicle. In order to “see” objects in various directions around the LIDAR receiver device, and to determine directions of the objects, mechanical means may be used to scan across directions by the LIDAR system, e.g. the continuously rotating platform used in prior art patent U.S. Pat. No. 8,836,922. It is known that mechanical scanning parts, especially those continuously moving mechanical parts, are subject to failures with shorter mean time to failure (MTTF) and higher costs.

CW (continuous wave) and FMCW (frequency modulated continuous wave) Doppler LIDAR, as disclosed in prior patent U.S. Pat. No. 6,697,148 is a powerful sensing tool for applications such as ADAS and autonomous vehicles, however it performs speed and/or distance measurements at a single direction at a time. To sense objects in various directions, it may still have to use scanning means such as rotating mirror or other mechanically moving aiming means.

Furthermore, in time critical applications, not all directions of a LIDAR sensing data are of equal level of urgency. Sequentially scanning over the field of view and sequentially transferring the data is generally non-optimal and negatively affects detection and response time.

On the other hand, camera sensors are able to sense objects by colors, good at identifying traffic signs, and have other advantages under day light. Separately use the two types of optical sensors (LIDAR and camera) need extra efforts to align their angle of view, take more space to install, and use duplicated optics.

There is a need in the art to perform CW and/or FMCW Doppler detection and ranging in many or all directions of interest, without using mechanically moving parts, even without using any forms of scanning. There is also a need to differentiate sensing data obtained from various directions and convey the most urgent data with higher priority. Also there is need to combine LIDAR and camera sensors in one to get more advantages in cost and combined sensing performance.

### BRIEF SUMMARY OF THE INVENTION

In one aspect, the invention provides an embodiment of an optical sensor chip, comprising: an array of pixels; and an interface module, coupled with the pixels, for conveying sensing results outside the sensor chip; wherein at least some of the pixels are Doppler sensing pixels comprising: an LO (local oscillator)-pumped photo-detector, coupled with the interface module, for detecting a modulated light signal, and mixing with at least one pump signal to produce a least one mixing product electrical signal(s).

In another aspect, at least one embodiment of the invention provides an optical sensor chip, comprising at least one of an array of mixed camera sensing pixels and LIDAR sensing pixels; and an array of dual function pixels, which sense both camera information and LIDAR information, including at least one of a color of visible light and a direction of a sensed portion of an object; a strength of visible light and a direction of a sensed portion of an object; a strength of light in an infrared range and a direction of a sensed portion of an object; a strength of light in an ultraviolet range and a direction of a sensed portion of an object; a human-invisible color in an infrared range and a direction of a sensed portion of an object; a human-invisible color in an ultraviolet range and a direction of a sensed portion of an object; at least one quantity that is able to derive a range (distance), and a direction of an object; and at least one quantity that is able to derive a velocity of an object, and a direction in field of view of said object.

In yet another aspect, at least one embodiment of the invention provides an apparatus for detecting a frequency shift in an amplitude envelope waveform of an optical signal, comprising at least one of: at least one avalanche photodiode (APD); at least one single-photon avalanche diode (SPAD); and at least one photo-sensing device whose optical to electrical conversion rate depends on an instantaneous bias voltage; wherein said APD, SPAD or photo-sensing device is biased by a time-varying voltage based, at least in part, on a replica signal of the amplitude envelope waveform.

Other aspects of the invention will become clear thereafter in the detailed description of the preferred embodiments and the claims.

### BRIEF DESCRIPTION OF THE DRAWINGS

For a better understanding of the invention and to show more clearly how it may be carried into effect, reference will now be made, by way of example only, to the accompanying drawings which illustrate distinctive features of at least one exemplary embodiment of the invention, in which:

FIG. 1, by way of example, illustrates a functional block diagram of a Doppler LIDAR receiver device using a LIDAR sensor with Doppler sensing pixels;

FIG. 2 is a block diagram showing functions built into individual Doppler sensing pixels on the sensor chip shown in FIG. 1;

FIG. 3 illustrates an exemplary embodiment of an omnidirectional Doppler LIDAR for detecting objects in a space of hemisphere;

FIG. 4 is a concept illustration of an electronically reconstructed Doppler sensing panorama superimposed onto an a visible light panorama;

FIG. 5 illustrates another exemplary embodiment of an omnidirectional Doppler LIDAR for detecting objects in both upper and lower hemispheres;

FIG. 6 illustrates yet another exemplary embodiment of an omnidirectional Doppler LIDAR for detecting objects in both upper and lower hemispheres;

FIG. 7 shows a block diagram of another preferred embodiment built into each of the Doppler sensing pixels on the sensor chip as shown in FIG. 1.

FIG. 8 shows an example of light path diagram that images project onto grating couplers on a sensor chip.

FIG. 9 shows an exemplary light path diagram in a preferred embodiment that improves efficiency of grating coupling using concave micro lens.

FIG. 10 shows an exemplary light path diagram in another preferred embodiment that improves efficiency of grating coupling using convex micro lens.

FIG. 11 shows another preferred embodiment of Doppler sensing pixel of light signals, using LO-pumped photo-detector.

### DETAILED DESCRIPTION OF THE INVENTION

It will be appreciated that in the description herein, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Furthermore, this description is not to be considered as limiting the scope of the invention, but rather as merely providing a particular preferred working embodiment thereof.

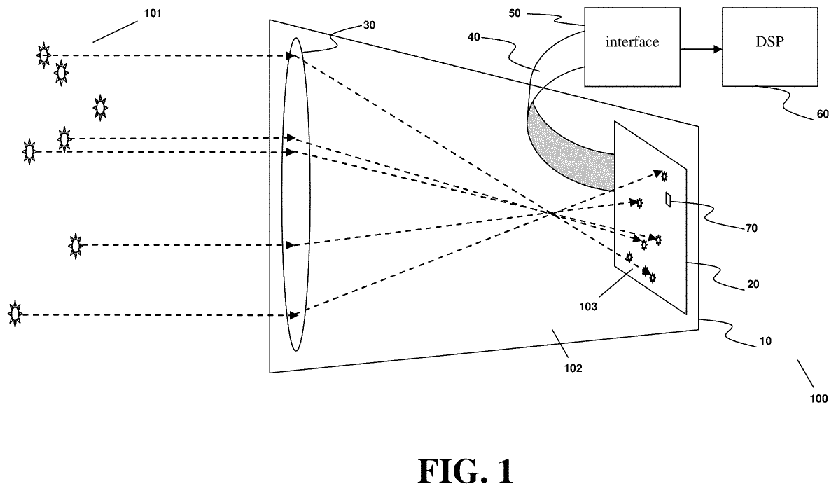

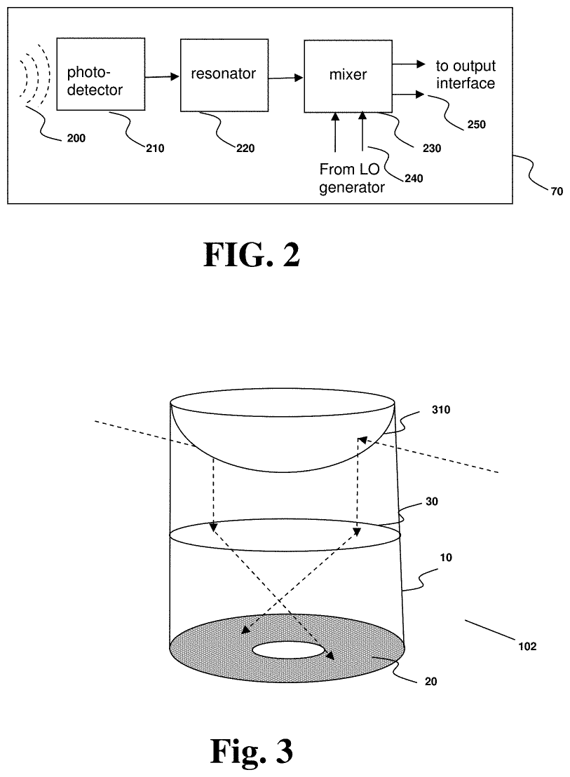

By way of example, FIG. 1 illustrates a functional diagram of a Doppler LIDAR receiver device using a LIDAR sensor with direct Doppler sensing pixels. In the figure, objects 101 illuminated by modulated light source (such as disclosed in patent U.S. Pat. No. 6,697,148), or lights emitted by modulated light beacons 101 (such as disclosed in patent application U.S. Ser. No. 16/917,805), which are attached to objects being sensed, are sensed by at least one LIDAR receiver device 100 in an application field, comprising of a Doppler sensing unit 102, a digital signal processor (DSP) module 60, an interface module 50 and interconnect wires 40. The Doppler sensing unit 102 includes a housing 10 that may be designed in different shapes to hold the components of the Doppler sensing unit, and suitable for being mounted on a platform using the sensing unit, such as a car; a LIDAR sensor chip 20 that contains an array of Doppler sensing pixels of light signal, e.g., the pixel 70 as one of them, which will be explained in more detail with FIG. 2 hereinafter; an optical scope 30 that may be as simple as a lens as shown in the drawing, or a pinhole (including a pinhole-equivalent structure), or may be more complex to include a plurality of lenses, optical filter(s), aperture control means, focal adjustment means, zoom adjustment means, may further include mirrors and optical fiber or light guide, etc. (not shown in drawing); the modulated light signals from objects 101, either reflected by surface of the objects, or directly emitted from a light beacon devices, will project their images 103 onto the pixels on the LIDAR sensor chip 20, being Doppler-sensed by individual pixels e.g., the pixel 70 as one of them, as will be explained with FIG. 2; and on the chip, a portion of the semiconductor area implements an interface circuit (not shown in drawing) to collect the Doppler sensing output signals from the pixels on chip, and through the wires 40 to pass the signals to the mating interface module 50 for further processing at DSP 60. As can be seen in the figure, direction information of individual objects, as long as within the scope of view, is indicated by positions of pixels in the array on chip, electronically represented by its address (position index of pixels), without the need of scanning using any moving mechanical means. The pixel address carries important information about direction of objects relative to the Doppler sensing unit 102. In certain applications, it may be desirable to place the pixels on chip unevenly so as to optimize resolution of direction detection, and/or compensate deformation caused by optics. The physical shape of individual pixels may not have to be square or rectangular and may use other shapes to optimize or make tradeoff of performances and/or costs. The drawing of FIG. 1 is not drawn to scale.

FIG. 2 is a block diagram showing functions built into each of the Doppler sensing pixels 70 on the sensor chip 20 shown in FIG. 1. The modulated light signal 200 from one of the objects 101 (of FIG. 1) may be exposed to a pixel 70 in question through the optical scope 30 (of FIG. 1). In a preferred embodiment, the pixel is on a focal plane of the optical scope 30 (of FIG. 1) for the objects under detection. The strength of the light signal 200 will get detected into electrical signal in an area of semiconductor on the pixel that functions as photo-detector 210. Preferably the photo sensing area of the photo-detector 210 is as large as possible in the allowed pixel area to increase sensitivity of sensing. In one embodiment, on top of a pixel, a micro optical lens may also be built to direct light coming to the pixel onto the effective photo-detector area. The output signal from the photo-detector in an analog signal that reflects the instantaneous light strength exposed to the sensing area, including the amplitude waveform modulated onto the light source, which is the wanted signal, also may include strength variations superimposed onto the sensing area from other light sources, which is unwanted interferences. To increase signal to interference ratio in output of the photo-detector, optionally and preferably a resonator 220 is implemented within the semiconductor area of the pixel 70, which may be a LC tuning circuit (inductor-capacitor tuning circuit) that resonates at the frequency band of the modulating signal (as used to modulate the light source, refer to prior art patent U.S. Pat. No. 6,697,148 and/or patent application U.S. Ser. No. 16/917,805), or may be a more sophisticated filter, to attenuate the frequency spectrum outside the modulating signal band of the modulated light signal. The photo-detector output signal, or filtered output signal of the photo-detector is then fed into a mixer 230, preferably an I-Q mixer, to be mixed with a local replica(s) 240 of the modulating signal or signals, which is a signal (or are signals) identical in frequency (or frequencies) to the one(s) used to modulate the light source. When an I-Q mixer is used, the local replica signal includes a phase shifted version of 90 degrees for each of the tone frequencies in use, as known to the skilled in the art. Also as an art known to the skilled, the mixer can be built in various ways, one simple embodiment is a diode ring, each of the I/Q arms is built by four diodes. More sophisticated multipliers such as four quadrant multiplier may also be used as long as suitable for the frequency in use and takes acceptable area of the pixel of semiconductor. It is well-known to the skilled in the art how to optimize the mixer circuit and local replica signal waveform and level, e.g., using a rectangular wave counterpart of local replica, combining the local replica components vs. separately mixing each of the components of local replica signal. The output of the mixer is a mixing product signal 250, containing Doppler shifts in a CW modulated use case, also containing frequency shifts if FMCW signal is used in modulating the light source, which can be used to derive range (distance) of the object sensed by the pixel in question. As an art known to the skilled, the way of deriving speed and range (distance) is not explained herein. The local replica signal(s) is shown in the figure as coming from a LO (local oscillator) generator, in embodiments where the modulated light source is co-located in the same device (e.g., as in patent U.S. Pat. No. 6,697,148) the LO generator may be simply the one used in the light transmitter; whereas in embodiments where the modulated light source is away from the LIDAR receiver device, e.g., the beacon embodiment or the illuminator embodiment as disclosed in patent application U.S. Ser. No. 16/917,805, the LO generator may need to be built according to what teaches in application U.S. Ser. No. 16/917,805. In either case, the generator produces the local replica signal(s) to feed all pixels on the sensor chip 20. Preferably the mixing product signals from the mixer 230 are amplified before sending out of the pixels, and the amplifier (not shown in drawing) may be implemented as a part of the mixer 230. Since not the entire area of the pixel silicon are used for implementing the photo-detector, for improved sensitivity and signal to noise ratio, in a preferred embodiment, an optical micro lens (not shown in drawing) may be placed on top of each pixel to direct more lights exposed onto the pixel to the silicon or semiconductor area of the photo-detector.

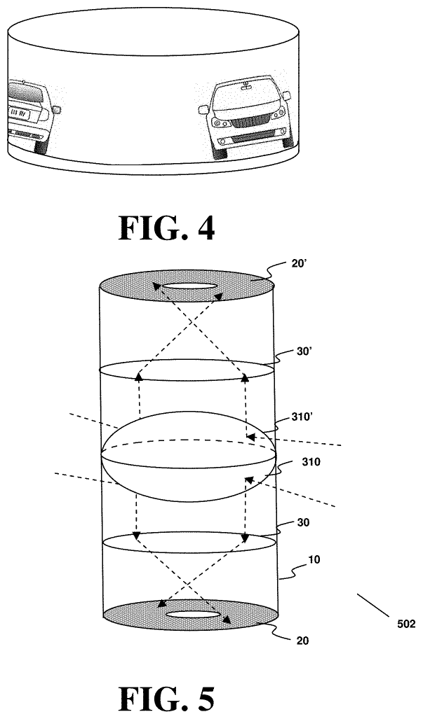

The area containing Doppler sensing pixel array in sensor chip 20 does not have to use rectangular shape, in some application scenarios, shapes other than rectangular may be preferred. FIG. 3 illustrates an exemplary embodiment of an omnidirectional Doppler sensing unit 102, in which the sensing unit structure is supported by a housing 10 which is transparent for the upper portion to allow light signals to come in from all 360 degrees around the horizontal plane and nearly entire lower hemisphere; a lens or a set of lenses 30 makes the images focus on the sensing pixels on Doppler sensor chip 20; a specially designed convex mirror 310, which may be built according to what patent U.S. Pat. No. 6,744,569 teaches, reflects light signals of objects from all directions around horizontal plane and lower hemisphere onto the sensor pixels on chip 20. As will be appreciated, the effective sensing area of the pixel array may be preferred to shape as a ring plate, and through DSP means, the images sensed by the pixel array on the ring plate shaped area may be electronically reconstructed into a Doppler sensing Panorama, superimposed onto an a visible light Panorama as needed, for example, like the one shown in FIG. 4 for human viewing. For machine sensing and autonomous driving purpose, reconstructing into a Panorama might not be necessary, as driving decisions may be as conveniently made based on sensed information as “flattened” on a ring shaped plate. The drawing of FIG. 3 is for purpose of showing concepts, and is not drawn to scale. The center part and corners of the silicon not used for building pixels may be used to build supplementary circuits for the chip, e.g., the interface, LO buffering and distribution, power regulation and distribution, which will not be elaborated herein.

For pixel array of rectangular shape on the sensor chip, individual pixels may be evenly placed according to grids of Cartesian coordinates, parallel to the edges, and address of the pixels are numbered accordingly, to represent direction of sensed objects. For pixel arrays of circular shape or ring shape, the individual pixels may be places along polar coordinates, e.g., spaced by equal polar angle and radial length to reflect equal angular step size of incoming lights from objects that form images at positions of pixels. Since in some applications, not all directions are of equal importance, multiple zones on the pixel array may be implemented with different pixel densities. Unevenly spaced pixels may be implemented to correct optical deformity as well.

FIG. 5 illustrates another exemplary embodiment of an omnidirectional Doppler sensing unit 502, to be able to sense objects in both lower and upper hemispheres, which is essentially a duplicated sensing unit structure as in FIG. 3 and is not elaborated again herein. Again the drawing of FIG. 5 is for purpose of showing concepts, and is not drawn to scale.

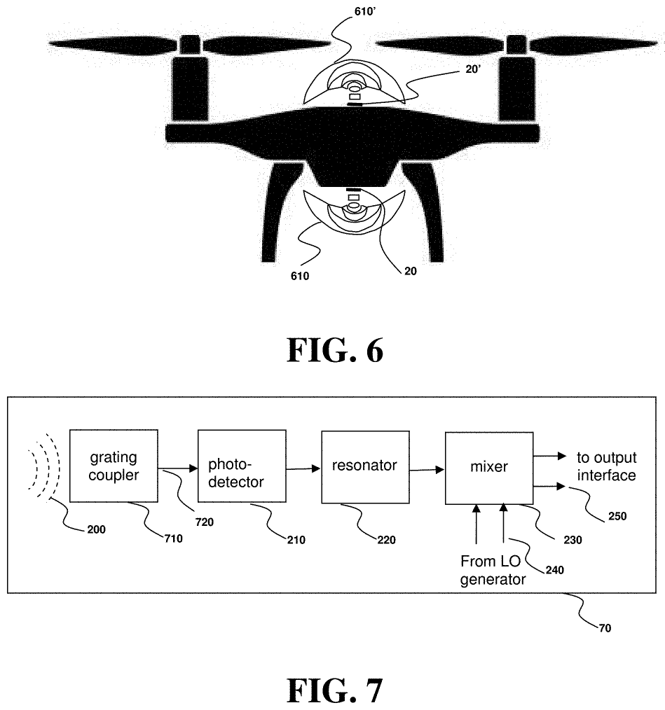

In an alternative embodiment, the convex mirror(s) and the scope(s) in embodiments of FIGS. 3 and 5 may be replaced by a fish-eye optical scope and achieve nearly 180 degree view of a hemisphere, and two of such structure together will be able to perform Doppler sensing substantially in both upper and lower hemispheres. FIG. 6 shows an example of such omnidirectional Doppler sensing unit, in which the two Doppler sensors 20 and 20′ are placed on upper and lower side of a drone, and fish-eye scopes 610 and 610′ are installed in front of the sensor chips to project omnidirectional image onto the Doppler sensors 20 and 20′, one to sense the lower hemisphere and the other to sense the upper hemisphere (The drawing is not drawn to scale).

FIG. 7 is another preferred embodiment built into each of the Doppler sensing pixels 70 on the sensor chip 20 as shown in FIG. 1. The modulated light signal 200 from one of the objects 101 (of FIG. 1) may be exposed to a pixel 70 in question through the optical scope 30 (of FIG. 1). The light signal 200 is coupled into the chip by a grating coupler 710, and then further coupled optically to a photo-detector 210 via on-chip optical path 720 such as an optical waveguide. Preferably the grating coupler 710 is tuned to the wavelength (frequency) of the modulated light source that illuminates the objects 101 (of FIG. 1) or to the wavelength (frequency) of beacons that are attached to objects being sensed (as disclosed in patent application U.S. Ser. No. 16/917,805). This way, lights in wavelengths away from the wavelength of the intended light sources are attenuated. The rest components 220, 230, function in the same way as described in FIG. 2 and is not described again.

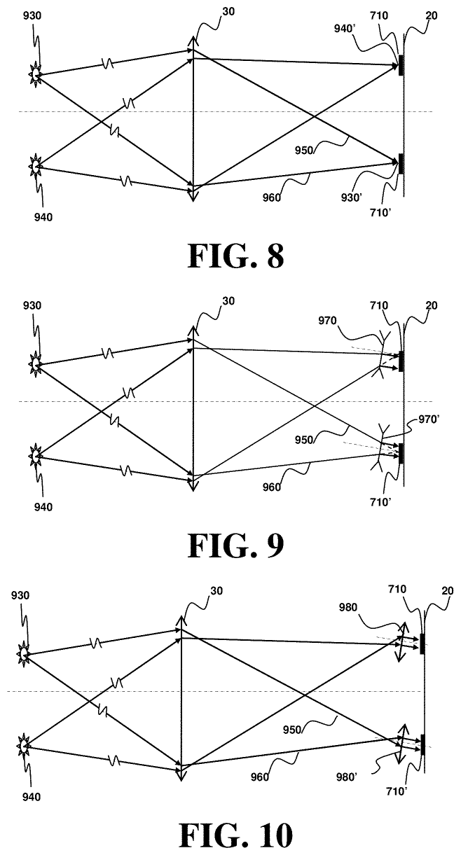

FIG. 8 shows an example of light path diagram that images project onto grating couplers on a sensor chip. In the figure, a portion of the sensor chip 20 is shown, as has been also described with FIG. 1. On the sensor chip 20, two grating couplers 710 and 710′ are drawn. In front of the sensor chip, an optical scope 30 is placed, like the arrangement shown in FIG. 1 described hereinabove. As examples, two object points 930 and 940, each reflects light from a LIDAR modulated light source (not shown in drawing), and the reflected light may expose onto the entire lens of the scope 30, and refracted to make images 930′ and 940′ on the chip 20, preferably the scope 30 focused right on the light sensing plane of the sensor chip 20. In the example, the images 940′ and 930′ are exposed onto the grating areas of the grating couplers 710 and 710′, respectively. As discussed with the embodiment of FIG. 7, the grating areas 710 and 710′ are a part of the surface areas of pixels (like the pixel 70 of FIG. 1) and the grating couplers 710 and 710′ are able to couple the lights from objects 940 and 930 inside the corresponding pixels for further processing. It also can be observed, however, that light signals from an object are exposed onto the grating with different incident angles, for example, lights from object 930 are exposed onto grating 710′ with many incident angles including, as shown in drawing, the exemplary rays 950 and 960. The light rays come from every part of the optical aperture of scope 30, there are many incident rays like 950 and 960. As known to the skilled in the art, the coupling efficiency of a grating coupler depends on the incident angle. For a light signal of given frequency, there exist an optimal incident angle. In order to improve the coupling efficiency, as shown in FIG. 9, in a preferred embodiment, a micro concave lens (e.g., 970, 970′ in the drawing) may be placed in front of each of the grating coupler areas of pixels to make the rays substantially parallel and at the optimal incident angle towards the grating surface. In this embodiment, the micro concave lens are preferably placed in a tilted angle so that the optical axes thereof are at the optimal incident angle towards the grating; the micro concave lenses are preferably placed at positions so that the focal points thereof are right at the surface of the gratings. Alternatively, by way of example as shown in FIG. 10, in another preferred embodiment, a micro convex lens (e.g., 980, 980′ in the drawing) may be placed in front of each of the grating coupler areas of pixels to make the rays substantially parallel and at the optimal incident angle towards the grating surface. In this embodiment, the micro convex lens are preferably placed in a tilted angle so that the optical axes thereof are at the optimal incident angle towards the grating; the micro convex lenses are preferably placed at positions so that the focal points thereof are on the focal image plane of the scope 30. The micro lens may also be formed by a plurality of lens pieces. The FIGS. 8, 9 and 10 are not drawn to scale.

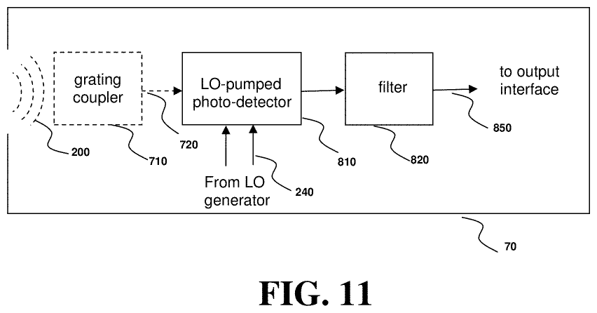

FIG. 11 shows another embodiment of Doppler sensing pixel 70 of light signals, using an LO (local oscillator)-pumped photo-detector. As compared with embodiments in FIGS. 2 and 7, the photo-detector 210 is replaced by an LO-pumped photo-detector 810, for detecting the modulated light signals 200. The light signal 200 may be coupled by a grating coupler 710 to the LO-pumped photo-detector 810 or be directly exposed to the LO-pumped photo-detector 810. Since the grating coupler 710 is optional, the functional block 710 is depicted using dashed line in the drawing. In the LO-pumped photo-detector 810, an avalanche photodiode (APD) or a single-photon avalanche diode (SPAD) device may be used as the detecting device of the modulated light signal 200, but different from a regular way of using an APD or SPAD, the reverse bias voltage of the APD or SPAD is not a constant DC voltage (such as a constant 150 Volts), but a reverse voltage that is varying at an LO frequency based on an LO signal 240 coming from an LO generator (not shown in the drawing), for example, an LO-gated varying voltage that varies in the range of 0 (or a low value) to reverse 150 Volts. As known in the art, an APD usually work under a reverse biased constant voltage lower than its breakdown voltage, and a SPAD usually work under a reverse biased constant voltage higher than its breakdown voltage but once beyond the breakdown voltage, a quench process, as known in the art, quickly kicks in to prevent the device from being damaged. If a SPAD is used in the pumped photo-detector, a quench means will also need to be implemented to prevent damage of device when instantaneous bias voltage goes beyond the breakdown point. Also known in the art that, the “avalanche gain” of a APD or a SPAD is not a constant, but exhibits strong nonlinearity—typically the gain becomes higher when the reverse bias voltage is higher, thus generating more current per unit number of photons exposed onto the device. In addition to the avalanche gain, the device also exhibits other nonlinearity such as the effective capacitance of the photodiode, although the device of a (conventional) APD or a (conventional) SPAD is not intentionally designed this way as a varactor diode. The nonlinearities of the avalanche gain and/or the effective capacitance will mixing the amplitude of the input light signal with the LO pump signal, and output a mixing product signal at sum and difference frequencies (of the LO and the light amplitude) in the current through the APD or SPAD. Since the pump signal of LO is very strong, and the input modulated light signal may be very weak, the output mixing product may be stronger than the input, realizing an amplifying effect. This amplifying effect is similar to a “parametric amplifier” as known in the art. What different from a parametric amplifier is, in this pumped photo-detecting process, input is an optical signal, and output is an electronic signal. In some embodiments, the LO signal is preferably at the exact instantaneous frequency of the modulating signal of the LIDAR transmitter, and one of the output mixing product signal components will be at baseband, also known as zero intermediate frequency (zero IF), in such embodiments it is preferable that the LO signal includes both an in-phase and a quadrature (in 90 degrees of phase shift) LO signals, and they separately pump a pair of APDs (or SPADs) and their output mixing products correspond to an in-phase and a quadrature signals in baseband channels. Another mixing product signal components will be at the doubled frequency. In an alternative preferred embodiment, the LO is shifted from the transmitter modulating signal frequency by a constant non-zero offset, so that a mixing product signal will at a non-zero IF frequency (i.e., around the non-zero offset frequency). In such embodiment, usually it is not is not necessary to have a quadrature branch implemented. A filter 820 will be preferably implemented to attenuate unwanted components in the mixing product signal(s), depending on embodiment, its pass-band may be in baseband (zero IF), around a non-zero IF, or at the double frequency band. In some embodiments, the filter may be a resonator. Comparing with embodiments in FIGS. 2 and 7, the separate mixer 240 disappeared and the function is combined with the LO-pumped photo-detector 810.

The amount of Doppler sensing data to be transferred out of the sensor chip 20 depends on 1) total number of pixels; 2) maximum bandwidth in the mixing product signals, which is proportional to the maximum Doppler shift of concern in the application, and in embodiments using FMCW modulating signal, it also depends on FM sweeping rate and maximum range in design. If the data interface is able to convey all digitized data from all pixels, then the chip may simply passing the mixing product signals through an anti-aliasing filter (not shown in drawings of FIGS. 1 and 2) and then use analog to digital converter (not shown in drawings too) to digitize the filtered analog signal, time multiplexing the data by the interface circuits on chip (not shown in drawings), and send them out. If the amount of data is too large to be all passed, it is preferable to locally pre-process the result and select to pass only the output signals from “important” pixels, or provide variable amount of data dependent of determined priority of pixels.

What pixels are “important”? How does the sensor chip 20 determine it? The answer is application dependent. Take the example of autonomous vehicle application in a “controlled” traffic region, in which all vehicles are equipped with beacon transmitters (e.g., the ones described in patent application U.S. Ser. No. 16/917,805), and all land structure in the region are also marked by such beacons, then the important pixels may be those with beacon signals exposed onto them that are much stronger than reflected background signals. The ones with closer distances and positive Doppler shifts (i.e., approaching objects) are most important ones since they are the objects may have higher potential risk of collisions with the vehicle in question. In application scenarios to detect reflected signals, the signal strength may not be a reliable measure as the signal strength depends not only on distance and size of objects, but also depends on surface properties of objects. In this case, a high positive Doppler as well as close distance may be good criteria for selecting important pixels to output data.

On-chip hot spot detection is a pre-selection of pixels and their neighboring ones that need to watch with higher attention, so as to output these data to off-chip DSP for further processing. For signal strength based selection, may use sum-and-dump (integrate and discharge) of absolute values/magnitude of mixing product signals at a given time interval, and pass the results to a threshold; for Doppler shift based selection, estimators of frequency or angular speed (of phase) may be used, e.g., an estimator based on frequency counter may use threshold comparator (preferably with appropriate amount of hysteresis) to detect and count number of “sign” changes in the mixing product signals from mixers that mix with CW local replicas during a given time interval to determine, or alternatively based on time needed for a given number of “sign” changes thereof to determine, and in either case, may choose to only count the “sign” changes in the direction of phase rotations for positive Doppler shifts (approaching objects). As known in the art, distance may also be determined based on frequency information using FMCW technique. In the selection of important pixels, quick and potentially less accurate processing may be used, and relying on more accurate further processing on DSP 60 for final processing.

Alternatively, in another preferred embodiment, since both distance and radial velocity of an object can be derived from frequency information of the mixing product signals of the pixels, instead of output the raw mixing product signals, the pixels may only output the detected frequency values or a quantity associated with the frequency, such as a phase angular rate. Frequency estimators (or equivalent) may be implemented in the pixels to obtain the detected values of frequency or quantities associated with the frequency. Frequency estimators are well known to the skilled in the art, including the examples in the previous paragraph. In further alternative embodiment, pixels may output estimated frequency values as baseline output, and based on feedback from external DSP 60, some subset of pixels are selected to provide raw digitized mixing product signals.

Priority based data interface protocol is an important feature for massive sensing data device in time critical, mission critical and/or consequence critical applications, such as the example discussed herein—the massive parallel sensing pixels of a LIDAR in autonomous vehicle control. In the following paragraphs, we describe some preferred embodiments of data interface protocol suitable for the LIDAR architecture disclosed in this patent application as well as in the priority applications (application Ser. No. 16/926,400 and application Ser. No. 17/126,623), as well as the camera sensing data as will be described hereinafter.

In one preferred embodiment, a set of initial sensing data may be conveyed with equal priority, and may simply convey sensing data of all pixels with a low initial update rate (on a simple “frame by frame” basis); alternatively, to quickly get an overall picture, may reduce initial resolution among pixels, for example only convey one pixel data every L pixels in column numbers and one every P in row numbers. The output of each of the pixels may be transferred out by a truncated limited length block, and pixels are served one by one in a sequential order according to the pixel location addresses, such as by incremental column numbers of each row and then by incrementing the row numbers. After receiving and processing the initial data, the DSP processor 60, will provider a feedback table to the sensor chip 20 that each of the pixels is assigned to a priority level i, where i=1,2, . . . , N. According to the priority level assigned in the table, the sensor chip 20 will adjust the data conveying settings onwards and continue to receive new feedback tables from the DSP processor 60, and readjust data conveying settings accordingly. Alternatively, the feedback table provided by the DSP processor 60 may contain more parameters than just N priority levels, for example, may include sampling rate, block size, update rate, and order of pixels to send data, etc. When the DSP processor 60 is detecting the LIDAR orientation is in change, for example, when a vehicle is making a turn, the feedback table may provide aiming adjust parameters predicted. The table may also include additional moving prediction parameters. For example, when a set of pixels related to a brick on road in the lane driving along, the set of pixels may currently be assigned to a high priority for data transfer, and predict a new set of pixels after moving, and assigning them to high priority automatically in next period of time without further feedback.

In another preferred embodiment, in addition to determining data conveying parameters based on feedback from the DSP processor 60, the chip may also implement on-chip preprocessing to determine priority of pixels to convey data from. This will react more quickly to sudden changes. For example, in highway driving condition, the LIDAR may be installed on a car that follows another car driving in the same direction, feedback from the DSP processor 60 may be very good in determining pixel data priority corresponding to surrounding cars that already for a while exist in the field of view, and the pixels corresponding to the open sky, but may not react quickly enough if a brick on the highway previously blocked by the car in front suddenly appears after the front car no longer blocks its view. On-chip processing must quickly determine the sudden change after being able to see the brick approaching at a high speed, and quickly assign the pixels around the image of the brick to a priority possibly even higher than the highest in the feedback table may have assigned to. The on-chip processing may not be as accurate, and may erroneously assign a high priority when it is not necessary, but the nature of time, mission and consequence critical control cannot afford missing or delaying any data for a truly dangerous event.

In addition to the raw sensing data (e.g., the digitized mixing product signal) or estimated/pre-processed sensing data (e.g., the estimated frequency values of mixing product signals, or quantities associated with the frequency), the contents of data output from each pixel may further include pixel position index in the array, timestamp, estimated level of time criticalness, estimated level of consequence criticalness, parameters related to data quality (level of confidence, e.g., signal strength, signal to interference ratio, margin toward saturation, level of platform vibrations, weather visibility, etc.), and time to next scheduled data.

According to level of time criticalness or level of priority, pixel data packets may be queued in a plurality of queuing data buffers, each queuing buffer is assigned to an update rate that needs to meet. A scheduler controls a multiplexer to select data among the queuing buffers to send through transmission channel. Among the plurality of queuing data buffers, data packet structure may be different, e.g., different block length, holding data of different sampling rate or decimating factor. For example, the pixels corresponding to the open sky may be queued in a buffer with low update rate, and high decimating factor in time and space (number of pixels to skip); pixels corresponding to or close to object boundaries (e.g., contours of vehicles, pedestrians, curbs, poles, lane line, and other objects) may be queued in a dedicated queue or queues. For certain purpose of processing, a set of adjacent pixels may be grouped to combine their mixing product signals into one single output, in a way forming a larger “super pixel”. Such sensing data may be queued separately with special settings of parameters for transmission.

In an alternative embodiment, the DSP 60 may be implemented on the sensor chip 20 in entirety or partially, so that processing of signals created by all pixels are performed within the chip 20, or at least in part.

In some application scenarios, it is desirable to illuminate surroundings simultaneously using said modulated light source, so that all directions of sensing interest will be illuminated. One embodiment to achieve this is to use the apparatus shown in FIG. 3 in a reversed light propagation direction, i.e., the modulated light source is placed at position of 20, emits the modulated light, and the light comes out through the optics 30 and is reflected by convex mirror 310 towards surrounding objects. Light energy may also be more densely focused towards directions that need longer illumination range, e.g., more concentrated towards front than back and sides in vehicular applications.

In applications such as autonomous vehicle, it is commonly known that, LIDAR and camera sensors each has advantages over the other and combining their sensing results to make driving decisions is required. If a camera sensor (of visible light or infrared light, for example) and a LIDAR sensor are separately installed, combining their sensing results need to align their angle of view and this process often is not an easy task when they go through separate optical scopes. The separate installation location causes offset in angle of view, also two sets of optics cause different image distortions and image sizes. Furthermore, physically combine the two types of sensors in one unified optical sensor will bring in more advantages. Furthermore, by sharing one set of optics will reduce cost. A unified optical sensor device also saves installation space and reduces decoration costs. In one embodiment, a unified camera and LIDAR sensor chip contains mixed two types pixels: camera sensing pixels, which may sense Red-Green-Blue colors and light intensity, similar or identical to the ones used in a camera sensor, and LIDAR sensing pixels, such as described in embodiments of FIGS. 2, 7, and 11, and may also include other types of LIDAR sensing pixels such as ones based on Time of Fly (ToF). The angle of view information is represented by the physical position of the pixels on a chip, and the two types of sensing information is inherently aligned in their angles of view. Alternatively, pixels may each be implemented to sense both camera information and LIDAR information. In either of the embodiments, micro optical filters may be placed on top of the photo sensing areas of pixels to selectively pass red, green, blue and LIDAR sensing used infrared wavelength bands. Other color separating and/or selective color sensing technologies known in the arts may also be used. Priority determination methods described hereinabove may be used to determine not only priority in transferring LIDAR sensing information but also in transferring corresponding camera sensing information of same pixels (or pixels closed by) through priority based interface described hereinabove. Since camera sensing pixels are well known in the art, it is not described in further detail herein.

Certain terms are used to refer to particular components. As one skilled in the art will appreciate, people may refer to a component by different names. It is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances.

Also, the term “couple” in any form is intended to mean either a direct or indirect connection through other devices and connections.

It should be understood that various modifications can be made to the embodiments described and illustrated herein, without departing from the invention, the scope of which is defined in the appended claims.

I claim:

1. An optical sensor chip, comprising:
an array of pixels; and
an interface module, coupled with the pixels, for conveying sensor data outside the sensor chip;
wherein at least some of the pixels are Doppler sensing pixels, comprising:
an LO (local oscillator)-pumped photo-detector, coupled with the interface module, for detecting a modulated light signal, and mixing with at least one pump signal to produce a least one mixing product electrical signal(s).

2. The Doppler sensing pixels of claim 1, each further includes at least one of:
at least one filter, coupled with the LO-pumped photo-detector, for attenuating frequency components outside band of interest in the mixing product signal or signals;
a first estimator, coupled with the LO-pumped photo-detector, for estimating a frequency or a quantity associated with a frequency of the mixing product signal(s); and
a second estimator, coupled with the LO-pumped photo-detector, for estimating at least one of a signal strength or a signal to interference and noise ratio of the modulated light signal.

3. The Doppler sensing pixels of claim 1, each further includes:
a grating coupler, coupled optically with the LO-pumped photo-detector, for selectively coupling the modulated light signal at a given wavelength band into the LO-pumped photo-detector.

4. The Doppler sensing pixels of claim 3, each further includes a micro optical lens on top of each said grating coupler, for directing light being exposed onto said grating coupler with substantially parallel light rays at a desired incident angle.

5. The Doppler sensing pixels of claim 2, provide a sensing data in forms of at least one of:
digitized mixing product signal(s);
estimated frequency of the mixing product signal(s);
estimated quantities related to the frequency of the mixing product signal(s);
estimated signal strength;
a velocity of an object being sensed by said pixel;
a range (distance) of an object being sensed by said pixel; and
a signal strength from an object being sensed by said pixel.

6. The LO-pumped photo-detector of claim 1, comprises at least one of:
at least one avalanche photodiode (APD);
at least one single-photon avalanche diode (SPAD); and
at least one photo-sensing device which exhibits an optical to electrical conversion rate that is dependent on an instantaneous bias voltage;
which is biased by a time-varying voltage based, at least in part, on at least one said pump signal.

7. The LO-pumped photo-detector of claim 6, further includes at least one component whose effective capacitance varies with the at least one pump signal.

8. The LO-pumped photo-detector of claim 7, said at least one component is a part of a tuning circuit.

9. An optical sensor chip, comprising at least one of:
an array of mixed camera sensing pixels and LIDAR sensing pixels; and
an array of dual function pixels which sense both camera information and LIDAR information.

10. The optical sensor chip of claim 9 wherein said array of dual function pixels, array of mixed camera sensing pixels and LIDAR sensing pixels are placed on the chip in an area of at least one of:
a rectangular shape;
a round shape;
a ring shape;
an oval shape;
an oval ring shape; and
a curved belt shape.

11. The optical sensor chip of claim 9 wherein said array of dual function pixels, array of mixed camera sensing pixels and LIDAR sensing pixels are placed on the chip and spaced according to at least one of:
Cartesian coordinates; and
polar coordinates.

12. The optical sensor chip of claim 9 wherein said array of dual function pixels, array of mixed camera sensing pixels and LIDAR sensing pixels (herein referred generally to as “the pixels”) are placed on the chip in a plurality of zones, and wherein, in each of the zones the pixels are placed evenly according to one of a Cartesian or a polar coordinates, and densities of placement are based on the zone the pixels belong to.

13. The optical sensor chip of claim 9, wherein the pixels (the camera sensing pixels, LIDAR sensing pixels and the dual function pixels) are operable to sense and/or indicate, in field of view, at least one of:
a color of visible light and a direction of a sensed portion of an object;
a strength of visible light and a direction of a sensed portion of an object;
a strength of light in an infrared range and a direction of a sensed portion of an object;
a strength of light in an ultraviolet range and a direction of a sensed portion of an object;
a human-invisible color in an infrared range and a direction of a sensed portion of an object;
a human-invisible color in an ultraviolet range and a direction of a sensed portion of an object;
at least one quantity that is able to derive a range (distance), and a direction of an object; and
at least one quantity that is able to derive a velocity of an object, and a direction in field of view of said object.

14. The optical sensor chip of claim 9 is operable to sense the camera information and the LIDAR information that can correspond with each other in an angle of view.

15. The optical sensor chip of claim 9 is operable to perform at least one of:
determining a priority of sensed data;
sharing said determined priority between a camera sensing data and a LIDAR sensing data obtained by one said dual function pixel or obtained by a pair of adjacent camera sensing pixel and LIDAR sensing pixel; and
transferring both said LIDAR sensing data and said camera sensing data based, at least in part, on said determined and/or shared priority.

16. The optical sensor chip of claim 9 further includes micro optical filters for selectively passing red, green, blue and other light wavelength bands of lights and light signals.

17. An apparatus for detecting a frequency shift in an amplitude envelope waveform of an optical signal, comprising at least one of:
at least one avalanche photodiode (APD);
at least one single-photon avalanche diode (SPAD); and
at least one photo-sensing device whose optical to electrical conversion rate depends on an instantaneous bias voltage;
wherein said APD, SPAD or photo-sensing device is biased by a time-varying voltage based, at least in part, on a replica signal of the amplitude envelope waveform.

18. The apparatus of claim 17 further includes at least one of:
at least one amplifier, coupled with said APD, SPAD or said photo-sensing device, for amplifying an electrical signal sensed from the optical signal;
at lease one filter or tuning circuit, coupled with said APD, SPAD or said photo-sensing device, for attenuating unwanted sideband of mixing product signals and frequency components outside a band of interest;
a frequency estimator, coupled with said APD, SPAD or said photo-sensing device, for estimating an frequency of a mixing product signal;
at least one grating coupler, optically coupled with said APD, SPAD or said photo-sensing device, for selectively coupling optical signals into said APD, SPAD or said photo-sensing device; and
an optical filter, placed in a ray path of said optical signal, for selectively passing and stopping components of light wavelengths.
